(19) United States
(12) Patent Application Publication
(10) Pub. No.: US 2020/0229636 A1
(43) Pub. Date: Jul. 23, 2020

(54) COOKING POT HAVING A STRAINER

(71) Applicant: Joe Thomason, Lexington, NC (US)

(72) Inventor: Joe Thomason, Lexington, NC (US)

(21) Appl. No.: 16/251,778

(22) Filed: Jan. 18, 2019

(51) Int. Cl. A47J 36/08; A47J 27/08

(52) U.S. Cl. CPC A47J 36/08; A47J 27/0804

(57) ABSTRACT

A cooking pot, including a cylindrical surface disposed around a base to store at least one of a liquid and a type of food, a strainer disposed within a lower portion of the cylindrical surface to empty the at least one of the liquid and the type of food, and a slidable lid disposed within a lower portion of the cylindrical surface to cover the strainer when the slidable lid is in a first position and to uncover the strainer when the slidable lid is in a second position.

### BACKGROUND

### 1. Field

The present general inventive concept relates generally to a strainer, and particularly, to a cooking pot having a strainer.

### 2. Description of the Related Art

In cooking and baking, there may be times when a chef needs to separate ingredients, but cannot do so by hand alone. In particular, the chef might want to separate different sizes of particle items from each other, such as salt and flour, or cleaning vegetables with water. These situations would require the use of a sieve or colander.

Most known sieves, such as a strainer have many uses in the kitchen as they can be used to sift flour, dust a finished cake with confectioners' sugar, or strain lumps out of any kind of soup, sauce, or pudding. Though not often glamorized as a stand mixer or blender, strainers are still a staple kitchen accessory that can be enhanced to further functionality. Unfortunately, cooking pots don't have a means to strain unless the contents are poured into a separate strainer.

Therefore, there is a need for a cooking pot that has a strainer integrated therein.

### SUMMARY

The present general inventive concept provides a cooking pot having a strainer.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a cooking pot, including a cylindrical surface disposed around a base to store at least one of a liquid and a type of food, a strainer disposed within a lower portion of the cylindrical surface to empty the at least one of the liquid and the type of food, and a slidable lid disposed within a lower portion of the cylindrical surface to cover the strainer when the slidable lid is in a first position and to uncover the strainer when the slidable lid is in a second position.

The cooking pot may further include a pair of lid-retraining grooves having a latch-receiving aperture, the pair of lid-retaining grooves disposed within a lower portion of the cylindrical surface, such that a portion of an edge of the slidable lid is disposed within a first groove of the pair of lid-retaining grooves and a portion of another edge of the slidable lid is disposed within a second groove of the pair of lid-retaining grooves, such that the slidable lid moves within the pair of lid-retaining grooves from the first position to the second position.

The slidable lid may include a watertight sealing member disposed on an inner surface of the slidable lid to prevent at least one of the liquid and the type of food from leaking from the cooking pot when the slidable lid is in the first position, a lid handle disposed on an outer surface of the slidable lid to manipulate the slidable lid, and a latch disposed on at least a portion of an edge of the slidable lid to prevent the slidable lid from moving when the slidable lid is closed and the latch is inserted into the latch-receiving aperture.

The latch may retract into the slidable lid in response to a manipulation of the lid handle, such that the slidable lid is opened by moving the slidable lid away from the strainer and the slidable lid is closed by moving the slidable lid toward the strainer.

The lid handle may be pulled to retract the latch.

The lid handle may be rotated to retract the latch.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side view of a cooking pot having a strainer, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

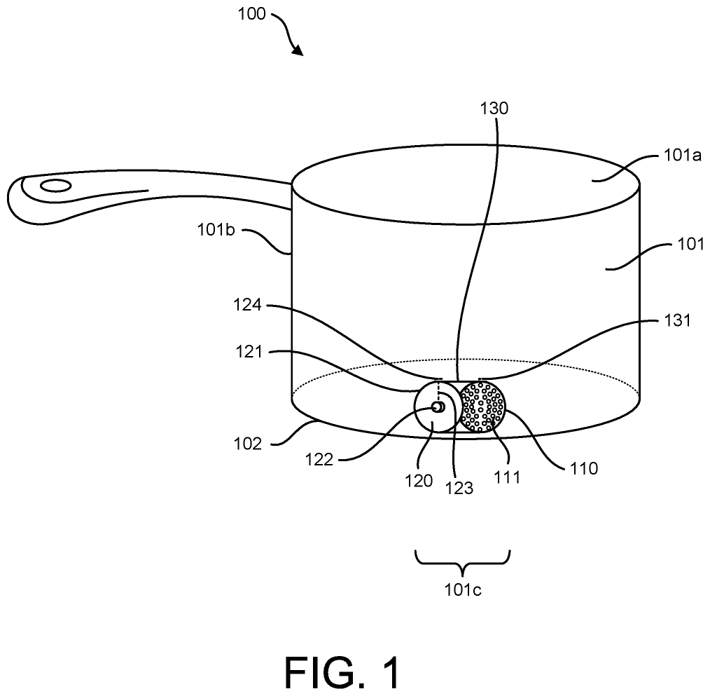

FIG. 1 illustrates a side view of a cooking pot 100 having a strainer 110, according to an exemplary embodiment of the present general inventive concept.

The cooking pot 100 may be constructed from at least one of tempered metal, plastic, wood, glass, and rubber, etc., but is not limited thereto.

The cooking pot 100 may include a cylindrical surface 101, a base 102, the strainer 110, a slidable lid 120, and a pair of lid-retaining grooves 130, but is not limited thereto.

Referring to FIG. 1, the cooking pot 100 is illustrated to have a cylindrical shape. However, the cooking pot 100 may be rectangular, rectangular prism, pentagonal, hexagonal, octagonal, or any other shape known to one of ordinary skill in the art, but is not limited thereto.

The cylindrical surface 101 may include an inner surface 101a and an outer surface 101b, but is not limited thereto.

The cylindrical surface 101 may be disposed around the base 102, such that at least one liquid and/or at least one type of food may be stored therein.

The strainer 110 may include a plurality of holes 111, but is not limited thereto.

Referring to FIG. 1, the plurality of holes 111 is illustrated to have a circular shape. However, the plurality of holes 111 may be slits that are rectangular, rectangular prism, pentagonal, hexagonal, octagonal, or any other shape known to one of ordinary skill in the art, but is not limited thereto.

The strainer 110 may be disposed within at least a lower portion of the cylindrical surface 101 substantially near the base 102. Specifically, the strainer 110 may be visible within an interior of the cooking pot 100 and an exterior of the cooking pot 100. Moreover, the strainer 110 may be disposed within a recessed portion 101c with respect to the outer surface 101b. The plurality of holes 111 may be disposed on at least an interior portion of the strainer 110, such that a liquid and/or a type of food having a diameter less than a diameter of at least one of the plurality of holes 111 can move through at least one of the plurality of holes 111 from the inner surface 101a to at least the outer surface 101b.

The slidable lid 120 may include a watertight sealing member 121, a lid handle 122, a rod 123, and a latch 124, but is not limited thereto.

The watertight sealing member 121 may include rubber, silicone, latex, or any other material known to one of ordinary skill in the art, but is not limited thereto.

The pair of lid-retaining grooves 130 may include a latch-receiving aperture 131, but is not limited thereto.

The pair of lid-retaining grooves 130 may be disposed within at least a lower portion of the cylindrical surface 101 near the strainer 110.

The slidable lid 120 may be disposed within a portion of the pair of lid-retaining grooves 130. Specifically, at least a portion of an edge of the slidable lid 120 may be disposed within a first groove of the pair of lid-retaining grooves 130 and at least a portion of another edge of the slidable lid 120 may be disposed within a second groove of the pair of lid-retaining grooves 130.

The watertight sealing member 121 may be disposed on an inner surface of the slidable lid 120. The lid handle 122 may be disposed on at least a center portion of an outer surface of the slidable lid 120. The rod 123 may be disposed within at least a portion of the slidable lid 120. The latch 124 may be disposed on at least a portion of an edge of the slidable lid 120.

Referring to FIG. 1, the slidable lid 120 may be opened by a user manipulating the lid handle 122. Specifically, the user may push and/or pull the lid handle 122, such that the rod 123 moves the latch 124 away from the latch-receiving aperture 131. In other words, the latch 124 retracts into the slidable lid 120 in response to the user manipulating the lid handle 122. Alternatively, the user may rotate the lid handle 122, such that the rod 123 causes the latch 124 to retract into the slidable lid 120. The user may not open the slidable lid 120 until the lid handle 122 is manipulated as described above.

The user may open the slidable lid 120 while the latch 124 is retracted by pushing and/or pulling the slidable lid 120, such that the slidable lid 120 moves in a direction away from the strainer 110. The user may subsequently close the slidable lid 120 by pushing and/or pulling the slidable lid 120 in a direction toward the strainer 110, such that the slidable lid 120 covers the strainer 110 and the latch 124 is inserted into the latch-receiving aperture 131.

In other words, the slidable lid 120 may be disposed within a lower portion of the cylindrical surface 101 to cover the strainer 110 when the slidable lid 120 is in a first position (i.e., a closed position), and to uncover the strainer 110 when the slidable lid 120 is in a second position (i.e., an open position).

When the slidable lid 120 is open, the user may empty certain contents from the cooking pot 100 using the strainer 110. Specifically, the user may orient the cooking pot 100, such that the contents are directed toward the strainer 110. As such, the user does not need to fully empty the cooking pot 100 into a separate strainer (not illustrated).

Furthermore, the watertight sealing member 121 prevents any contents within the cooking pot 100 from leaking out when the slidable lid 120 is closed. Additionally, the slidable lid 120 and the lid handle 122 may be thermally insulated, or may be constructed from heat dissipating material, in order to prevent the user from being burnt when manipulating the slidable lid 120.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A cooking pot, comprising:
a cylindrical surface disposed around a base to store at least one of a liquid and a type of food;
a strainer disposed within a lower portion of the cylindrical surface to empty the at least one of the liquid and the type of food from an inner surface of the cylindrical surface to an outer surface of the cylindrical surface; and
a slidable lid disposed within a lower portion of the cylindrical surface to cover the strainer when the slidable lid is in a first position and to uncover the strainer when the slidable lid is in a second position.

2. The cooking pot of claim 1, further comprising:
a pair of lid-retaining grooves having a latch-receiving aperture, the pair of lid-retaining grooves disposed within a lower portion of the cylindrical surface, such that a portion of an edge of the slidable lid is disposed within a first groove of the pair of lid-retaining grooves and a portion of another edge of the slidable lid is disposed within a second groove of the pair of lid-retaining grooves, such that the slidable lid moves within the pair of lid-retaining grooves from the first position to the second position.

3. The cooking pot of claim 1, wherein the slidable lid further comprises:
a watertight sealing member disposed on an inner surface of the slidable lid to prevent at least one of the liquid and the type of food from leaking from the cooking pot when the slidable lid is in the first position;
a lid handle disposed on an outer surface of the slidable lid to manipulate the slidable lid; and
a latch disposed on at least a portion of an edge of the slidable lid to prevent the slidable lid from moving when the slidable lid is closed and the latch is inserted into the latch-receiving aperture.

4. The cooking pot of claim 3, wherein the latch retracts into the slidable lid in response to a manipulation of the lid handle, such that the slidable lid is opened by moving the slidable lid away from the strainer and the slidable lid is closed by moving the slidable lid toward the strainer.

5. The cooking pot of claim 4, wherein the lid handle is pulled to retract the latch.

6. The cooking pot of claim 4, wherein the lid handle is rotated to retract the latch.

7. A cooking pot, comprising:
a cylindrical surface disposed around a base to store at least one of a liquid and a type of food;
a strainer disposed within a recessed portion of an outer surface of the cylindrical surface to empty the at least one of the liquid and the type of food therefrom; and
a circular slidable lid disposed within a lower portion of the cylindrical surface to cover the strainer in a first position, and to uncover the strainer in a second position, such that the circular slidable lid is visible from an interior of the cylindrical surface via the strainer.
